(19) United States
(12) Patent Application Publication
(10) Pub. No.: US 2025/0382727 A1
(43) Pub. Date: Dec. 18, 2025

(54) HEMP PROCESSING SYSTEMS AND METHODS

(71) Applicant: Andrew OSCAR, Atlanta, GA (US)

(72) Inventor: Andrew OSCAR, Atlanta, GA (US)

(21) Appl. No.: 18/878,184

(22) PCT Filed: Jun. 28, 2023
(86) PCT No.: PCT/US2023/026392

§ 371 Date: Dec. 23, 2024

Related U.S. Application Data
(60) Provisional application No. 63/356,208, filed on Jun. 28, 2022.

(51) Int. Cl. D01B 1/26; D01B 1/32; D01B 1/38

(52) U.S. Cl. CPC D01B 1/26; D01B 1/32; D01B 1/38

(57) ABSTRACT

A system having a mill apparatus, a first screening apparatus, and a fiber collection apparatus. The mill apparatus receives hemp material, and the first screening apparatus receives milled hemp material from the mill apparatus. The first screening apparatus separates fiber components of the milled hemp material from hurd, grain, and biomass components of the milled hemp material. The fiber collection apparatus receives, from the first screening apparatus, the fiber components of the milled hemp material. Optionally, a second screening apparatus can receive, from the first screening apparatus, the hurd, grain, and biomass components of the milled hemp material, and the second screening apparatus can separate the hurd, grain, and biomass components. Also described are methods of using the disclosed system to separate fiber, hurd, grain, and biomass components of hemp material.

### CROSS-REFERENCE TO RELATED APPLICATION

This application claims priority to and the benefit of the filing date of U.S. Provisional Patent Application No. 63/356,208, filed Jun. 28, 2022, the entire contents of which are incorporated herein by reference.

### BACKGROUND

Hemp is an agricultural crop traditionally grown for fiber and grain production. It is scientifically classified as Cannabis sativa L., and legally defined as cannabis that possesses less than.3% of the psychoactive cannabinoid, THC (delta 9 tetrahydrocannabinol). Hemp was legalized under the 2018 Farm Bill, and the USDA published rules during the fall of 2019. Certified hemp genetics are stabilized to produce less than 3% THC.

Hemp stalks are composed of two materials: bast fiber that occurs in a thin epidermal layer of outer bark; and hurd, an inner woody core under the bark layer. These two materials are present in ratios ranging from 1:3 to 1:4 of bast fiber to hurd. Hemp crops can produce significant stalk biomass ranging from 2.5 to 5 tons per acre and even higher. These yields are achieved with lower water requirements than other crops, and with minimal to no pesticide or herbicide applications. Because of these properties, hemp is considered to be a sustainable crop for farmers and an excellent regenerative material for industry.

However, there is an absence of processing infrastructure to convert hemp stalks into salable commodities or marketable products for industry. These needs and others can be met by the systems and methods of the present disclosure.

### SUMMARY

In accordance with the purpose(s) of the present disclosure, as embodied and broadly described herein, the present disclosure, in one aspect, relates to systems and methods for processing hemp material. Optionally, the hemp material can be processed on a farm site or at or on a side of a field where hemp material is being harvested.

In various aspects, a system includes a mill apparatus, a first screening apparatus, and a fiber collection apparatus. The mill apparatus can be configured to receive hemp material. The first screening apparatus can be configured to receive milled hemp material from the mill apparatus. The first screening apparatus can be configured to separate fiber components of the milled hemp material from hurd, grain, and biomass components of the milled hemp material. The fiber collection apparatus can be configured to receive, from the first screening apparatus, the fiber components of the milled hemp material.

Optionally, the system can also include a second screening apparatus that is configured to receive, from the first screening apparatus, the hurd, grain, and biomass components of the milled hemp material. The second screening apparatus can be configured to separate the hurd, grain, and biomass components.

Optionally, the system can also include a hurd collection apparatus, a grain collection apparatus, and a biomass collection apparatus. The hurd collection apparatus can be configured to receive, from the second screening apparatus, the hurd components of the milled hemp material. The grain collection apparatus can be configured to receive, from the second screening apparatus, the grain components of the milled hemp material. The biomass collection apparatus can be configured to receive, from the second screening apparatus, the biomass components of the milled hemp material.

In other aspects, a method can include milling, by the mill apparatus, hemp material. The method can further include separating, by the first screening apparatus, fiber components of the milled hemp material from hurd, grain, and biomass components of the milled hemp material. The method can further include collecting, by the fiber collection apparatus, the fiber components of the milled hemp material.

Optionally, in further aspects, the method can include separating, by a second screening apparatus, the hurd, grain, and biomass components of the milled hemp material. The method can further include collecting, by a hurd collection apparatus, the hurd components of the milled hemp material. The method can further include collecting, by a grain collection apparatus, the grain components of the milled hemp material. The method can further include collecting, by a biomass collection apparatus, the biomass components of the milled hemp material. Still further, the method can include packaging the collected fiber components of the milled hemp material. Still further, the method can include packaging the hurd components of the milled hemp material. Still further, the method can include packaging the grain components of the milled hemp material. Still further, the method can include packaging the biomass components of the milled hemp material. Optionally, the method can be performed onsite at a farm.

Still other objects and advantages of the present disclosure will become readily apparent by those skilled in the art from the following detailed description, wherein it is shown and described only the preferred aspects, simply by way of illustration of the best mode. As will be realized, the disclosure is capable of other and different aspects, and its several details are capable of modifications in various obvious respects, without departing from the disclosure. Accordingly, the description is to be regarded as illustrative in nature and not as restrictive.

### BRIEF DESCRIPTION OF THE FIGURES

The accompanying figures, which are incorporated in and constitute a part of this specification, illustrate several aspects and together with the description serve to explain the principles of the invention.

FIG. 1 is a representative schematic showing the flow process for the field-side hemp processing system.

FIG. 2 is a photograph of a base or mount portion of an exemplary hammer/wedge tip as disclosed herein.

FIGS. 3A-3C are representative schematics showing an exemplary hammer/wedge tip as disclosed herein. FIG. 3A is a side profile view, FIG. 3B is an end profile view, and FIG. 3C is a face view. FIGS. 3D-3E are schematic views depicting the use of a hammer mill having hammer/wedge tips as depicted in FIGS. 3A-3C. FIG. 3D is a schematic end view of a portion of the hammer mill during rotation, and FIG. 3E is a schematic side view of the portion of the hammer mill during rotation. FIG. 3F is a plan view of an exemplary top screen for use in the hammer mill depicted in FIGS. 3D-3E. FIG. 3G is a plan view of an exemplary bottom screen for use in the hammer mill depicted in FIGS. 3D-3E. FIG. 3H is an image of an exemplary hammer mill as disclosed herein.

FIG. 4A-4D are representative schematics showing an exemplary trommel paddle agitator array as disclosed herein. FIG. 4A shows a movement sequence in which biomass “rides” up the side of the trommel screen as trommel rotation begins. FIG. 4B shows a movement sequence in which screen biomass clump “divers” form and begin to fall. FIG. 4C shows a movement sequence in which the “divers” impact the paddles, breaking apart and causing gravity powered counter rotation. FIG. 4D shows an overall schematic top view of an exemplary trommel screen paddle agitator array. FIG. 4E is a schematic side view of the trommel screen paddle agitator array of FIG. 4D. FIGS. 4F-4H are close-up views of mounts of the trommel screen paddle agitator array of FIG. 4D.

FIG. 5 is a representative photograph of hemp “divers” as disclosed herein.

FIG. 6A-6B are representative photographs of a deck screener as disclosed herein.

FIG. 7A-7F are representative diagrams depicting the steps for installation of a flip flow in a deck screener as disclosed herein. FIG. 7A instructs removal of the side tension media and the side tensioners of the deck screener. FIG. 7B instructs removal of the side wall brackets of the deck screener. FIG. 7C instructs removal of the side support of the deck screener. FIG. 7D instructs removal of the front support of the deck screener. FIG. 7E instructs flipping of the rear mounts of the deck screener by 180° such that the welded nuts are on top. FIG. 7F shows the correct final configuration before mounting 3D-Cassettes or flip-flow media.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present compositions, methods and systems may be understood more readily by reference to the following detailed description of preferred embodiments and the examples included therein and to the Figures and their previous and following description.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. Definitions

Listed below are definitions of various terms used to describe this invention. These definitions apply to the terms as they are used throughout this specification, unless otherwise limited in specific instances, either individually or as part of a larger group.

As used in the specification and in the claims, the term “comprising” can include the aspects “consisting of” and “consisting essentially of.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

“Optional” or “optionally” means that the subsequently described event or circumstance may or may not occur, and that the description includes instances where said event or circumstance occurs and instances where it does not.

As used herein, the term “by weight,” when used in conjunction with a component, unless specially stated to the contrary is based on the total weight of the formulation or composition in which the component is included. For example, if a particular element or component in a composition or article is said to have 8% by weight, it is understood that this percentage is in relation to a total compositional percentage of 100%.

A weight percent of a component, or weight %, or wt %, unless specifically stated to the contrary, is based on the total weight of the formulation or composition in which the component is included.

As used herein, “kit” means a collection of at least two components constituting the kit. Together, the components constitute a functional unit for a given purpose. Individual member components may be physically packaged together or separately. For example, a kit comprising an instruction for using the kit may or may not physically include the instruction with other individual member components. Instead, the instruction can be supplied as a separate member component, either in a paper form or an electronic form which may be supplied on computer readable memory device or downloaded from an internet website, or as recorded presentation.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

As used herein, the term “essentially,” in, for example, the context “essentially absent” refers to a composition having less than about 10% by weight, e.g., less than about 5%, less than about 1%, less than about 0.5%, less than about 0.1%, less than about 0.05%, or less than about 0.01% by weight of the stated material, based on the total weight of the composition.

It is further understood that the term “substantially,” when used in reference to a composition, refers to at least about 60% by weight, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature, component, or a combination of the components. It is further understood that if the composition comprises more than one component, the two or more components can be present in any ratio predetermined by one of ordinary skill in the art.

Disclosed are also components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

### B. Overview

Disclosed herein are hemp processing systems and methods. In exemplary aspects, a mobile whole hemp processing system can be provided. It is contemplated that the disclosed hemp processing systems can comprise a plant separation line or equipment stack provided at an “edge of field” location or onsite to reduce shipping costs and processing time from harvest. As further disclosed herein, the disclosed systems and methods can separate hemp material into four separate components: bast fiber, hurd, grain (seed) and biomass (flower). Once separated, the sizing of the various components can range from micronized particles to fibers having lengths greater than 12 inches.

As further described herein, the equipment stack can include mining, aggregate, industrial and/or ancillary equipment that has been modified from its conventional configurations to meet agricultural specifications or standards for application into the cellulous, fiber, protein, and biomass industries. In use, it is contemplated that the disclosed systems and methods can provide isolated hemp components that can be used to produce raw products and/or finished goods such as animal bedding, bioplastics, composite plastics, textiles, CBD biomass suitable for extraction, animal feed, engineered lumber, insulation, packaging, food, hempcrete, seed, and the like. In exemplary aspects, when the disclosed systems and methods are used, it is contemplated that a minimum of 5 different classifications of product can be produced in a single pass. Optionally, it is contemplated that the disclosed systems can operate at a rate no less than 30 tons (English) per hour of input hemp material.

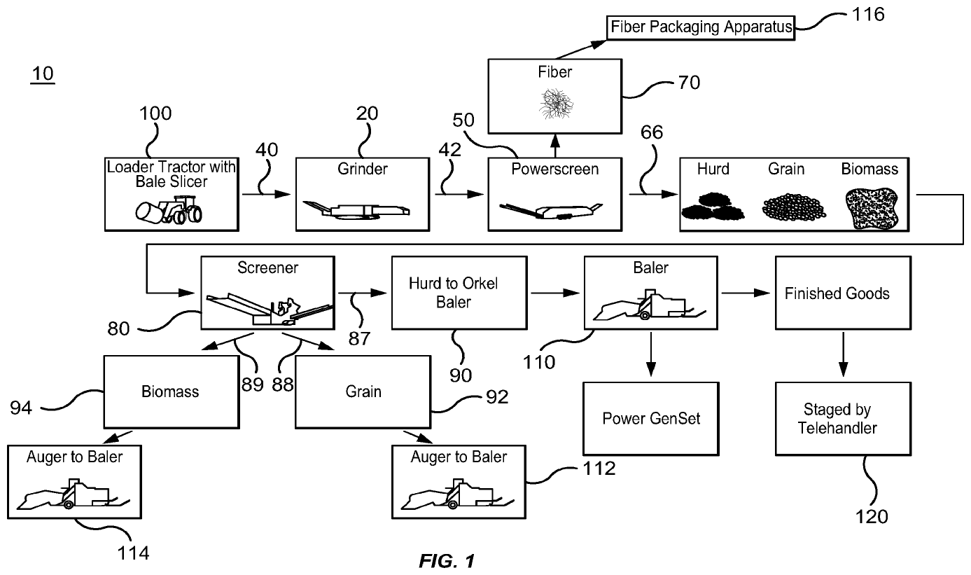

A process flow diagram is shown in FIG. 1. As shown, the system 10 can comprise a mill apparatus 20, a first screening apparatus 50, and a fiber collection apparatus 70. The mill apparatus 20 can be configured to receive hemp material. The first screening apparatus 50 can be configured to receive milled hemp material from the mill apparatus 20. In use, the first screening apparatus 50 can be configured to separate fiber components of the milled hemp material from hurd, grain, and biomass components of the milled hemp material. The fiber collection apparatus 70 can be configured to receive, from the first screening apparatus 50, the fiber components of the milled hemp material.

In further aspects, the system 10 can comprise a second screening apparatus 80 that is configured to receive, from the first screening apparatus 50, the hurd, grain, and biomass components of the milled hemp material. In use, the second screening apparatus 80 can be configured to separate the hurd, grain, and biomass components. In further aspects, the system 10 can comprise a hurd collection apparatus 90 that is configured to receive, from the second screening apparatus 80, the hurd components of the milled hemp material. In further aspects, the system 10 can comprise a grain collection apparatus 92 that is configured to receive, from the second screening apparatus 80, the grain components of the milled hemp material. In further aspects, the system 10 can comprise a biomass collection apparatus 94 that is configured to receive, from the second screening apparatus 80, the biomass components of the milled hemp material.

In still further aspects, it is contemplated that the system 10 can further comprise a loading apparatus 100 that is configured to deliver hemp material to the mill apparatus. In further aspects, the system 10 can comprise a fiber packaging apparatus 116 that packages fiber collected by the fiber collection apparatus 70. In further aspects, the system 10 can comprise a first (hurd) packaging apparatus 110 that packages hurd collected by the hurd collection apparatus 90, a second (grain) packaging apparatus 112 that packages grain collected by the grain collection apparatus 92, and/or a third (biomass) collection apparatus 114 that packages biomass collected by the biomass collection apparatus 94. In still further aspects, the system 10 can comprise a transport apparatus 120 that is configured to transport packaged hurd material (or other separated hemp components).

In use, it is contemplated that the disclosed systems and methods can reduce processing and operational farming costs by fully harvesting hemp in a single pass. Individual system components and process steps are described in more detail in the following sections.

### C. Input Material

Prior to processing as disclosed herein, the hemp material can cultivated using a swathed and baled technique. The hemp material can be cut, windrowed and retted in-field prior to baling to a moisture content ranging from about 8 percent to about 25 percent. Optionally, the minimum weight for the input hemp material can be 1,200 pounds, which allows for maintaining desired throughput capacities. In exemplary aspects, the hemp material can be provided to the mill apparatus as a bale or half bale. Optionally, in these aspects, the hemp material can be provided to the mill apparatus with wrapping (such as, for example, a wrapped bale). Optionally, when the hemp material is provided as a bale, the bale can be cut before the hemp material is provided to the mill apparatus such that the hemp material can be easily received within the mill apparatus. Although baled hemp material is provided as the input material in some examples, it is contemplated that loose to compacted material can also be processed using the disclosed systems and methods. For example, it is contemplated that the input material can optionally comprise hemp stalks.

### D. Loading

Input material can be fed into the mill apparatus 20 using a loading apparatus 100. In some aspects, the loading apparatus 100 can comprise a skid steer loader. In other aspects, the loading apparatus 100 can comprise a telehandler. In further aspects, the loading apparatus 100 can comprise a tractor. Optionally, in these aspects, the tractor can comprise a knife that is configured to cut a bale of hemp material. More particularly, it is contemplated that the tractor can be fitted with a bale knife that is capable of cutting the bale in half while retaining the bale or net wrap when placed upon an in-feed conveyor of the mill apparatus as further disclosed herein.

As a non-limiting example, the loading apparatus 100 can comprise a JOHN DEERE tractor having a bale knife, such as for example the tractor and bale knife associated with model BK60.

### E. Milling

Initial separation and liberation is done via the mill apparatus 20. In exemplary aspects, the mill apparatus 20 can comprise a horizontal block mill or grinder, such as, for example and without limitation, a CBI 6800BT horizontal grinder (CONTINENTAL BIOMASS INDUSTRIES (CBI)). In exemplary aspects, the mill apparatus can comprise a mill housing within which a mill rotor 44 is received.

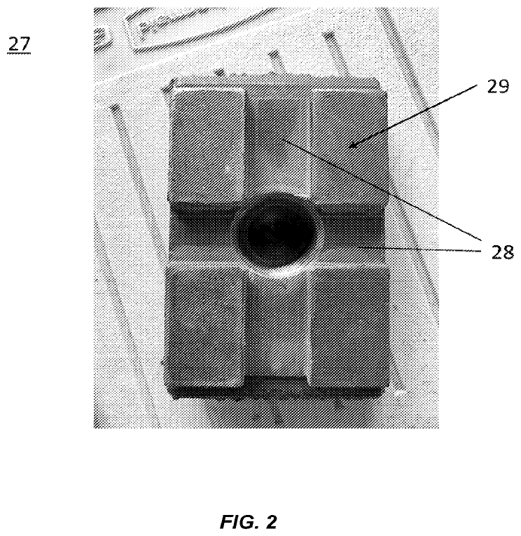

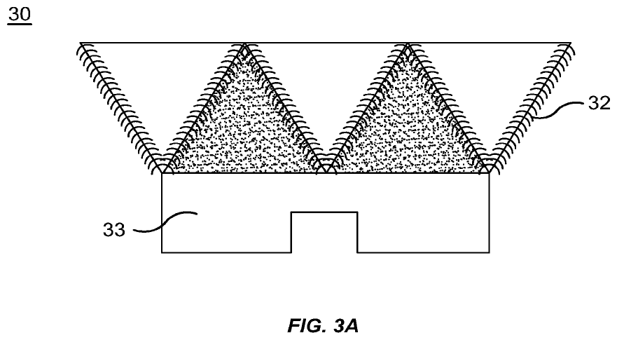

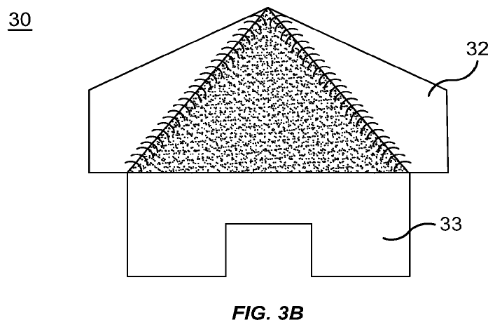

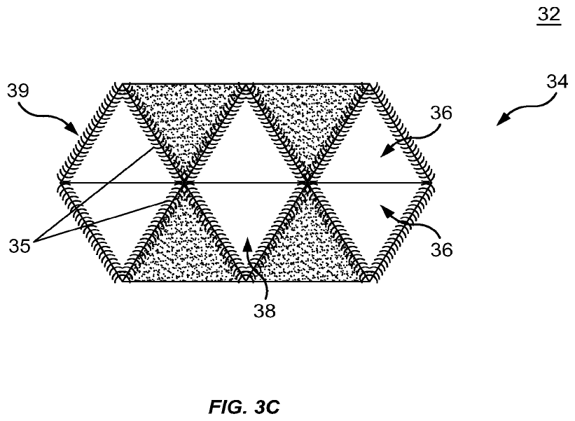

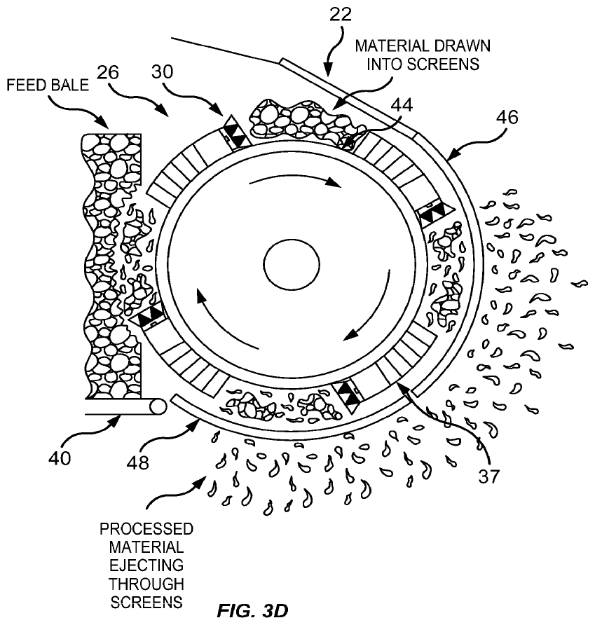

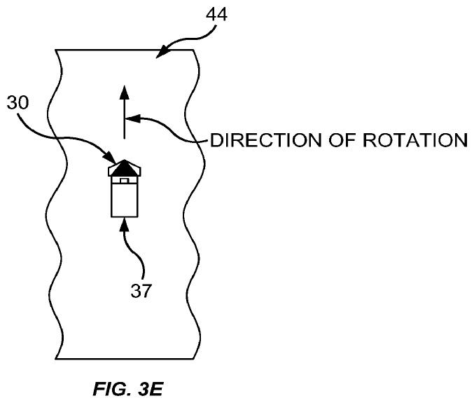

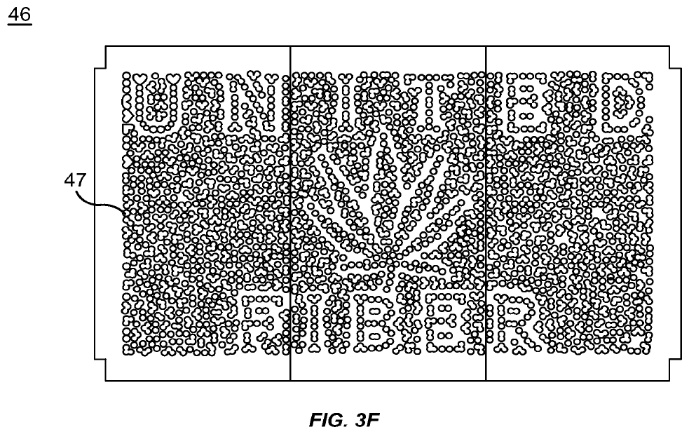

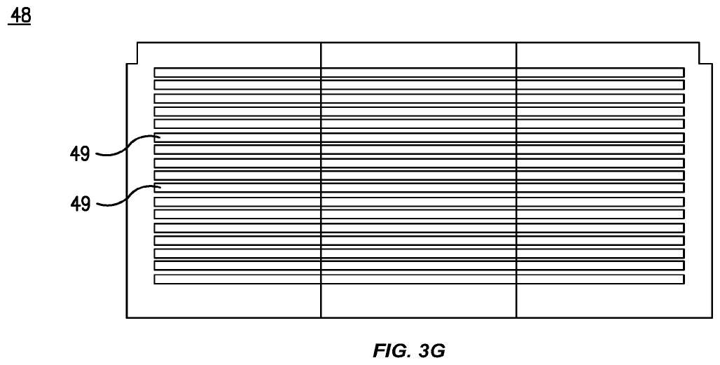

In some aspects, and as shown in FIGS. 2-3H, the mill apparatus 20 can comprise a plurality of hammers 26 that are positioned within a mill housing 22 that receives hemp material for milling/grinding and/or for separation from impact pressure from the mill rotor. In various aspects, the plurality of hammers 26 can be secured to (or otherwise fixedly coupled to) the mill rotor 44 such that the hammers 26 are configured for rotational motion within the mill apparatus 20. In exemplary aspects, each hammer 26 can comprise a wedge tip 30 and at least one hammer block 37. The wedge tip 30 can have a tip structure 32 and a base or mount portion 33 that is secured to the tip structure. The base or mount portion 33 can have a slot 28 that faces away from the tip structure 32 and defines a cross pattern 29. It is contemplated that the cross pattern 29 can form a blunt face that is configured to increase decortication efficiency. The base or mount portion 33 of the wedge tip 30 can be secured to one or more hammer blocks 37, which are secured or fixedly coupled to the outer circumference of mill rotor 44, which is configured to rotate about a rotational axis. In exemplary aspects, it is contemplated that the rotational axis of the rotor 44 can be perpendicular or substantially perpendicular to the axis along which material on the in-feed conveyor 40 moves. In some optional aspects, each hammer 26 can be welded to the mill rotor 44.

In exemplary aspects, and as shown in FIG. 3H, it is contemplated that the plurality of hammers 26 can be arranged into groups of hammers (e.g, “rows” of hammers) in which each hammer is both axially offset (along the rotational axis) and circumferentially offset (about the circumference of the rotor) from every other hammer of the group. Optionally, it is contemplated that the plurality of hammers can comprise a plurality of such rows of hammers, with sequential rows of hammers having hammers that are axially offset from one another.

In further aspects, and as shown in FIG. 3H, the mill apparatus 20 can comprise a plurality of cutting blocks 25. In these aspects, it is contemplated that the cutting blocks 25 can be secured to and project inwardly from an inner surface of the mill housing 22, facing the mill rotor 44. In use, it is contemplated that the cutting blocks 25 can cooperate with the plurality of hammers 26 to promote milling, grinding, and/or separation of hemp material as the material approaches the upper and lower screens as further disclosed herein. In exemplary aspects, it is contemplated that the plurality of cutting blocks 25 can be longitudinally offset from the plurality of hammers 26.

Although the hammers 26 are disclosed as rotating within the mill housing, it is contemplated that the hammers can be provided in alternative configurations, such as, for example and without limitation, configurations in which the hammers reciprocate axially.

Optionally, in these aspects, and with reference to FIGS. 3A-3C, it is contemplated that at least one hammer 26 of the plurality of hammers can have a tip structure 32 having a raised pattern 34 with angled surfaces 35 to increase a number of impact angles to aid in decortication and reduce “de-hulling” of the seed. In exemplary aspects, the tip structure 32 can comprise a plurality of triangular plates 36, which can optionally comprise plate steel (for example, ½ inch thick plate steel). In these aspects, at least a portion of the plurality of triangular plates 36 can be welded together. Optionally, the raised pattern 34 can comprise respective pairs of triangular plates 36 that cooperate to form one or more diamond-shaped sections 38 of the raised pattern. Optionally, the raised pattern 34 can comprise welds 39 that are impregnated with hard or wear-resistant material (such as, for example, carbide). In exemplary aspects, such welds can be ¼ inch welds. In use, it is contemplated that the disclosed raised pattern 34 can increase impact angles that aid in decortication while also reducing or avoiding the shelling of seed within the hemp material. In contrast, the use of solid or flat face patters as are conventional in hammer mills can break apart and damage the seed within the hemp material.

In some aspects, the mill apparatus 20 can comprise an in-feed conveyor 40 that is configured to receive the hemp material from the loading apparatus 100. After receiving the hemp material from the loading apparatus 100, the in-feed conveyor 40 can be configured to deliver the hemp material to the interior of the mill apparatus 20.

As further discussed above and depicted in FIGS. 3D and 3G-3H, from the area where hemp material is received by the interior of the mill apparatus 20, the rotor 44 of the mill apparatus 20 can be configured to rotate such that the hemp material is directed upwardly toward a top of the mill housing and then around toward the screen(s) of the milling apparatus as further disclosed herein.

In exemplary aspects, the mill apparatus 20 can comprise an upper screen 46 and a lower screen 48. In these aspects, it is contemplated that the lower screen 48 can be circumferentially offset from the upper screen 46 such that the rotor 44 and the hammers 26 direct hemp material toward the upper screen and then toward the lower screen. It is further contemplated that the upper screen 46 can be configured to perform the majority of screening of hemp material (e.g., greater than 50% of the screening work) within the mill apparatus. In further aspects, it is contemplated that the upper screen 46 can be configured to perform at least 60%, at least 65%, at least 70%, at least 75%, or at least 80% of the screening work within the mill apparatus (with the second screen 48 performing the remaining screening work).

In exemplary aspects, and with reference to FIG. 3F, the upper screen 46 can define a plurality of openings 47. In some aspects, the plurality of openings 47 can comprise openings having at least two different cross-sectional shapes, at least three different cross-sectional shapes, at least four different cross-sectional shapes, at least five different cross-sectional shapes, or at least six different cross-sectional shapes. In exemplary aspects, it is contemplated that each opening 47 of the plurality of openings can have cross-sectional dimensions of between about 0.5 inches and about 1.50 inches or between about 0.75 inches and about 1.25 inches. In some aspects, each cross-sectional dimension of each opening can be greater than or equal to 0.75 inches and less than or equal to 1.25 inches. Optionally, it is contemplated that the upper screen 46 can comprise margins (for example, three inch margins) on all sides, with no openings provided within the margins. Optionally, in some exemplary aspects, the upper screen can have a total area of between 2,000 and 3,000 square inches or between about 2,300 and about 2,600 square inches, with a total open area (corresponding to the total combined area of the openings) of at least 50% or at least 55%, at least 56%, at least 57%, at least 58%, at least 59%, or at least 60% of the total area of the upper screen. In exemplary aspects, it is contemplated that the variety of shapes and opening sizes provided within the upper screen can produce a hurd cut of “5 mesh,” with pieces having dimensions of about ¼ inch by about ¾ inch. In further exemplary aspects, it is contemplated that the upper screen 46 can have rounded corners to provide softened edges in the screened products.

In exemplary aspects, and with reference to FIG. 3G, the lower screen 48 can define a plurality of openings 49. Optionally, it is contemplated that the plurality of openings 49 can comprise a plurality of spaced slots (for example, 10 to 25 slots or 15 to 20 slots) that are spaced along an axis. In exemplary aspects, the plurality of spaced slots can have a consistent size and a consistent spacing along the axis. For example, in some aspects, each opening 49 can have a dimension along the axis of about 1 inch, and sequential openings can be spaced by about ½ inch along the axis. Optionally, in these aspects, it is contemplated that each opening 49 can have a transverse dimension ranging from 36 inches to 72 inches or from about 48 inches to about 60 inches. In exemplary aspects, the lower screen can have a total cross-sectional screen area ranging from 1,500 to 2,500 square inches or from about 1,850 to about 2,100 square inches. In exemplary aspects, the lower screen 48 can have margins along all sides where no openings are present. For example, in these aspects, the lower screen 48 can have margins at the top and sides of about 3 inches and a margin at the bottom of the screen of about 4 inches. In exemplary aspects, it is contemplated that the lower screen 48 can have a total open area of 750 square inches to 1,250 square inches or from about 925 square inches to about 1,050 square inches. In these aspects, it is contemplated that the total open area of the lower screen 48 can have a free area that corresponds to at least 45%, at least 46%, at least 47%, at least 48%, at least 49%, at least 50%, at least 51%, or at least 52% of the total cross-sectional area of the lower screen. In use, it is contemplated that the slotted openings of the lower screen 48 can facilitate screen evacuation to reduce fines (less than 30 Mesh) by reducing residency time.

Optionally, it is contemplated that some or all screens can be removed or omitted from the mill apparatus. For example, it is contemplated that screens can be removed in processes where it is necessary to separate flower and seed from biomass.

In some aspects, the mill apparatus 20 can comprise an outfeed conveyor 42 that is in communication with the first screening apparatus 50. In these aspects, after milled hemp material passes through the mill apparatus 20, the outfeed conveyor 42 can be configured to deliver the milled hemp material to the first screening apparatus 50.

Optionally, in some aspects, the mill apparatus 20 can be mounted to a chassis. In these aspects, it is contemplated that the mill apparatus 20 can be mounted to the chassis via tracks to which the mill apparatus is movably coupled. For example, it is contemplated that the mill housing, the infeed conveyor, and the outfeed conveyor can all be mounted to a single chassis. By mounting the mill apparatus 20 on tracks, it is contemplated that the mill apparatus can be positioned independently of transportation needs and can be considered self-contained.

In use, it is contemplated that the mill apparatus 20 can be configured with a rotor speed, which can be selected depending on the particular process in which the mill apparatus is being employed. For example, for hurd separation and decortication, it is contemplated that the rotor speed can be between about 1,400 and about 1,600 rotations per minute (RPM) or from about 1,400 to about 1,500 RPM. For seed, flower and biomass separation without decortication, it is contemplated that the rotor speed can be between about 600 and about 800 RPM or from about 700 to about 800 RPM. In various aspects, it is contemplated that the rotor size (optionally, a rotor diameter of 36 inches) can remain consistent while the wedge tips are selectively replaced with wedge tips having different sizes, shapes, materials, and/or properties, thereby modifying the overall diameter of the milling apparatus and proximity to the screen(s). It is further contemplated that wedge tip sizes and parameters, impact pressure, and/or screen sizing can be selectively modified to permit threshing and/or decorticating of the hemp material in a manner tailored for any desired commodities, application, or product (raw or finished good). In exemplary aspects, the power output of the mill apparatus can be selectively varied between about 150 horsepower and about 1,300 horsepower in order to process hemp material at a rate of at least 30 tons of input material per hour.

### F. Primary Screening

Primary screening is achieved via the first screening apparatus 50, which can comprise a rotary screen and/or trommel that removes the fiber components of the milled hemp material and further liberates the hurd, grain (seed), and biomass (flower) components from the fiber components.

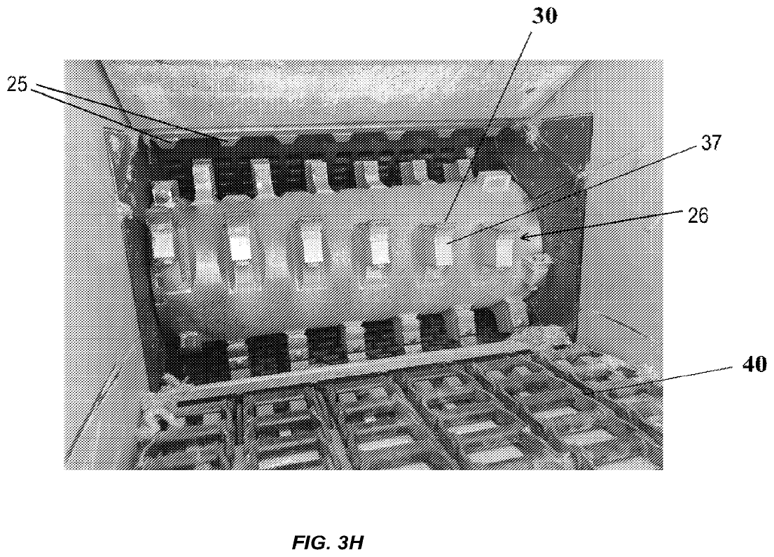

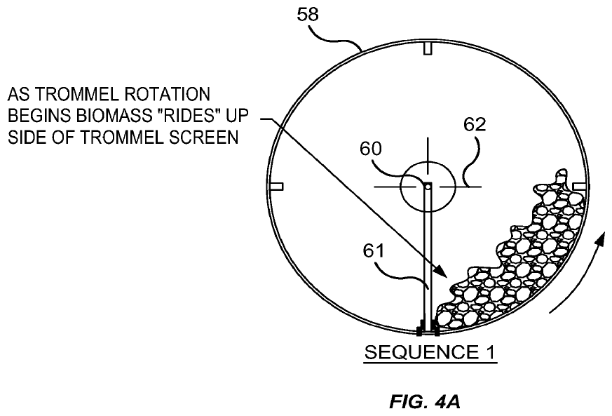

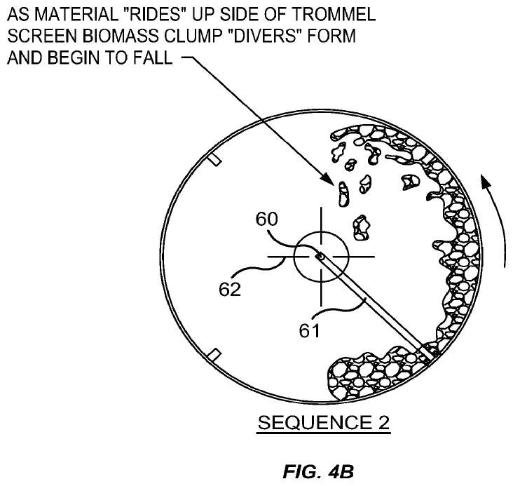

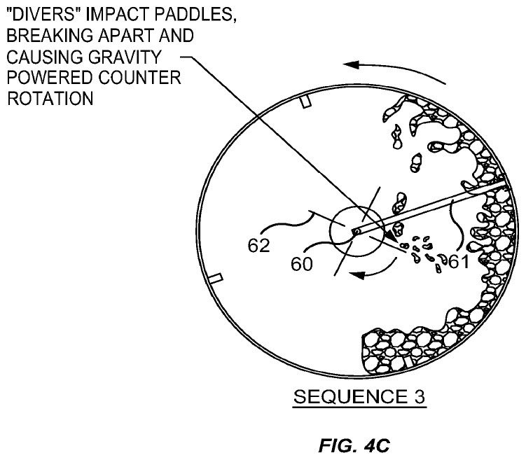

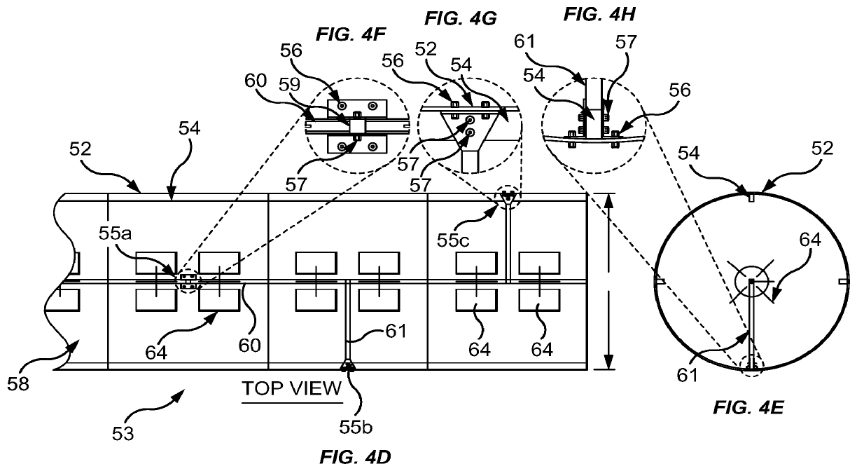

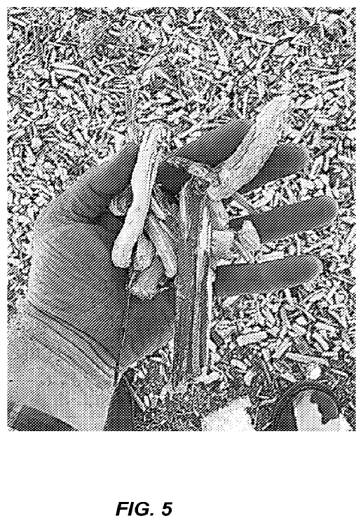

In exemplary aspects, and as shown in FIGS. 4A-4D, the first screening apparatus 50 can comprise a trommel having a screen 52 and a screen retainer 54. The screen can comprise a plurality of screen sections 53 (e.g., defining trommel sections) that circumferentially surround a receiving space. Edges of the screen sections can be mounted to the screen retainer 54. In exemplary aspects, the screen retainer 54 can comprise a frame structure with a plurality of circumferentially spaced frame elements that extend along the length of the trommel. Open spaces are provided between the frame elements to allow for hemp material to radially exit the openings of the screen 52. In some aspects, the first screening apparatus 50 can comprise an inlet hopper (not shown) in communication with the mill apparatus 20. As a non-limiting example, the trommel of the first screening apparatus 50 can be a POWERSCREEN Warrior 3300 trommel.

In exemplary aspects, the first screening apparatus 50 can comprise a barrel 58 having a length of at least 30 feet and a diameter of at least six feet, with the screen 52 and screen retainer 54 being received within the barrel 58. It is contemplated that the use of a six-foot barrel (such as in a six-foot trommel) is consistent with mining applications and is not typically considered for agricultural applications. As shown in FIG. 4D, the first screening apparatus 50 can further comprise a center shaft 60 that is rotatably coupled to the rotary screen 52. The center shaft 60 can be coupled to the rotary screen 52 by at least one support arm 61 (optionally, a plurality of support arms) that extends between and is coupled to the center shaft and the screen retainer and/or screen. A first end of each support arm 61 can be mounted to the screen retainer and/or rotary screen, and a second opposed end of each support arm can be rotatably coupled to the center shaft 60 such that the center shaft does not rotate with the rotary screen (e.g., rotation of the rotary screen does not effect a corresponding rotation of the center shaft). Optionally, each support arm 61 can comprise tube steel (e.g., 1.5 inch diameter tube steel).

The first screening apparatus 50 can further comprise at least one paddle assembly 62 (optionally a plurality of paddle assemblies) that is coupled (e.g., mounted or otherwise fixedly coupled) to the center shaft 60. Thus, the paddle assemblies 62 can rotate with the center shaft 60 such that rotation of the paddle assemblies effects a corresponding rotation of the center shaft. Each paddle assembly 62 of the at least one paddle assembly can comprise a plurality of paddles 64 (e.g., plate steel paddles, such as 3/16 inch plate steel paddles) that project radially away from the center shaft. In use, it is contemplated that the plurality of paddles 64 of each paddle assembly can be configured to effect rotation of the paddle assembly (and the center shaft) in response to impact between hemp material and at least one paddle of the plurality of paddles. As used herein, the term “paddle” is intended to include any structural element that extends radially away from the center shaft, including, for example and without limitation, arms, bars, baffles, and the like.

Optionally, in exemplary aspects, as shown in FIG. 4D, each support arm 61 (for example, each support arm of a plurality of support arms) can be mounted to the screen 52 by a respective mount to which the support arm is secured. When a plurality of support arms 61 are provided, the support arms 61 can be mounted to the screen at a plurality of circumferentially spaced mounts. For example, a first support arm can be mounted to the screen 52 at a bottom mount 55a, a second support arm can be mounted to the screen at a first side mount 55b, and a third support arm can be mounted to the screen at a second side mount 55c positioned opposite the first side mount (e.g., spaced circumferentially about 180 degrees from the first side mount). It is contemplated that this spacing can improve the effectiveness of the screening operation. One or more bolts 56 can secure each mount to the screen 52, and one or more bolts 57 can secure each mount to the screen retainer 57. The opposing end of each support arm is rotatably coupled to the center shaft by a bearing 59, which in exemplary aspects can circumferentially surround and be configured for rotation relative to the center shaft.

In operation, and as shown in FIGS. 4A-4C, the rotary screen 52 can rotate about an axis along which the center shaft extends. As the rotary screen rotates, hemp material can move upwardly along the sides of the screen (FIG. 4A). As hemp material continues to move upwardly, portions of the hemp material reach a position along the surface of the screen at which the hemp material falls downwardly (FIG. 4B). The downwardly falling hemp material contacts one or more of the paddles 64, and in response, the paddles effect rotation of the center shaft and their associated paddle assemblies 62 (FIG. 4C). In use, it is contemplated that a center of downward travel can be accounted for by modifying trommel speed and/or revolutions. Center of downward travel is adjusted to by trommel speed or revolutions per minute based on input material. In some exemplary aspects, the number of revolutions per minute can range from 9 to 15 or, more preferably, be 12, 13, or 14 revolutions per minute. In exemplary aspects, the paddle assemblies 62 can rotate in a direction opposite the direction of rotation of the screen 52. This process helps prevent the formation of clumps of matting and “divers” formed by biomass material and helps liberate hurd from fiber components. Thus, it is contemplated that the disclosed paddles can be configured and positioned on the interior of the barrel to rotate and agitate the hemp material to a vertical position, thereby allowing the weight of the material to fall and assisting with increased liberation.

Although the support arms 61 are disclosed herein as being coupled to the center shaft 60 such that rotation of the support arms does not effect corresponding rotation of the center shaft, in alternative aspects, it is contemplated that the support arms 61 can be fixedly coupled to the center shaft such that rotation of the support arms (and the rotary screen) effects a corresponding rotation of the center shaft. Optionally, in these aspects, it is contemplated that the paddle assemblies 62 can be rotatably coupled to the center shaft 60 such that rotation of the center shaft does not effect a corresponding rotation of the paddle assemblies. Thus, it is contemplated that the paddle assemblies 62 can rotate relative to the center shaft (for example, in response to contact with hemp material as disclosed herein). In one example configuration, the paddle assemblies 62 can be rotatably coupled to the center shaft by respective bearings or sleeves positioned around and configured to rotate relative to the center shaft.

In exemplary aspects, the rotary screen 52 can have openings with dimensions ranging from about ⅛ inch to about 1 inch. In further exemplary aspects, the rotary screen 52 can have a free or open area of at least 50%. In exemplary aspects, the rotary screen 52 can employ agricultural screens rather than the mesh panels that are typically employed in trommel systems.

Optionally, in some aspects, the barrel 58 (and screen 52) can be angularly oriented relative to horizontal, thereby promoting movement of the hemp material from one end of the barrel to the other. Optionally, in these aspects, the barrel can be at about 4 to about 6 degrees relative to horizontal.

In further exemplary aspects, the first screening apparatus 70 can comprise an outfeed conveyor 66 that is configured to receive hemp material passing through the rotary screen. In exemplary aspects, the outfeed conveyor 66 can comprise an “overs” conveyor and an “unders” conveyor, which can optionally be integral to a chassis, which can optionally be dolly mounted, with positioning and transportation done via a 5^{th} wheel hitch or is movably coupled. By mounting the first screening apparatus 70 on tracks, it is contemplated that the first screening apparatus can be positioned independently of transportation needs and can be considered self-contained. In exemplary aspects, the “unders” conveyor can direct hurd, grain (seed), and biomass (flower) components to the second screening apparatus 80 as further disclosed herein, while the “overs” conveyor can receive fiber components, which can be separately transported for re-baling or other packaging and processing.

Optionally, in use, it is contemplated that the first screening apparatus can use a power output ranging from about 50 to about 150 horsepower in order to permit processing of at least 30 tons of material per hour. The out-feed conveyor from the mill is fed to the inlet hopper of the trommel.

### G. Secondary Screening

Secondary screening can be accomplished using the second screening apparatus 80, which can move in at least two axes to bounce and vibrate the hemp material received from the first screening apparatus 50. In exemplary aspects, the second screening apparatus 80 has an inlet hopper 82 that is in communication with the first screening apparatus 50.

Optionally, the second screening apparatus can be a deck screener configured to move (e.g., vibrate, shake, etc.) in at least two axes (optionally, three or more axes). In exemplary aspects, the deck screener can have dimensions of at least five feet by at least 15 feet (and up to 22 feet).

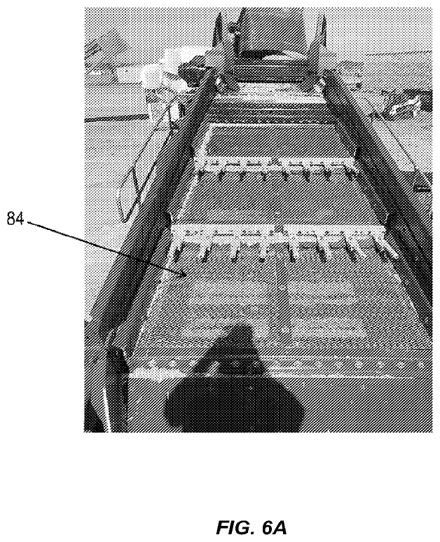

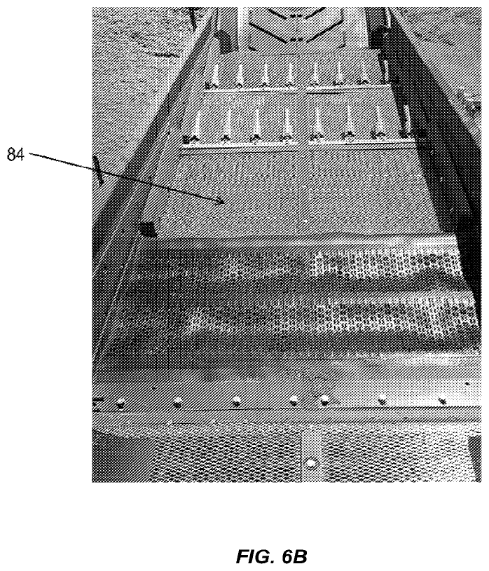

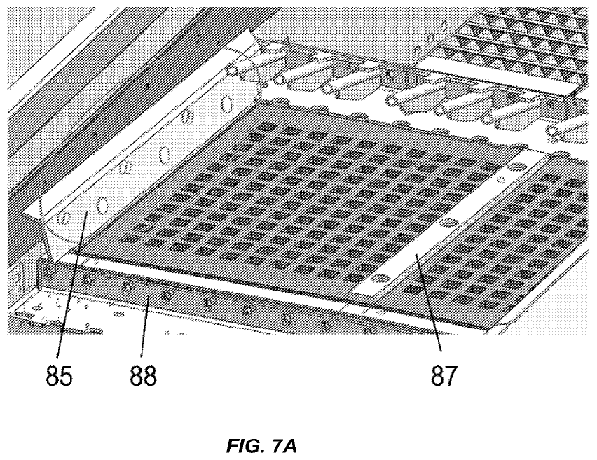

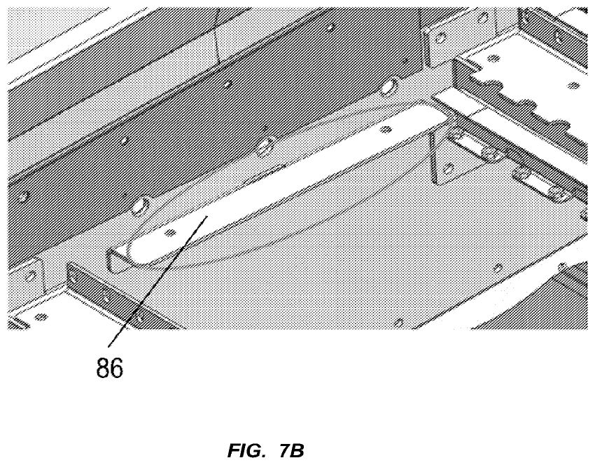

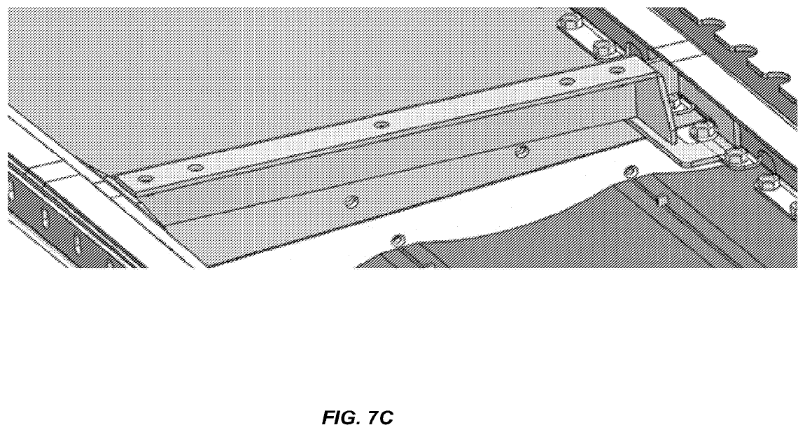

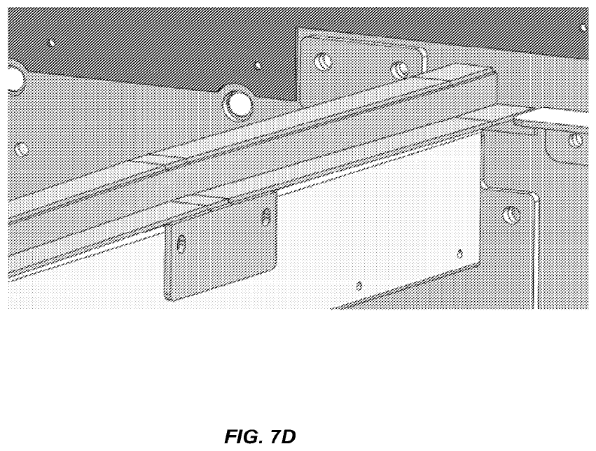

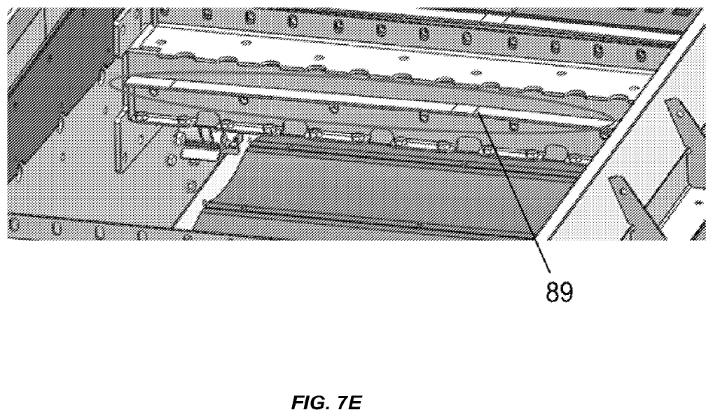

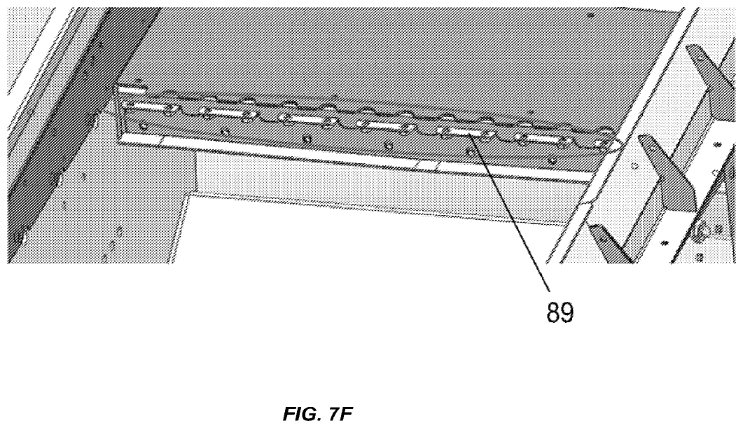

In exemplary aspects, and with reference to FIGS. 6A-6B, the second screening apparatus 80 can comprise a screen 84. For example, the screen 84 can be a flow-flow screen, such as, for example and without limitation, the SPALECK 165T Flip-Flow Screen. In this example, it is contemplated that the standard configuration of the Flip-Flow Screen can be modified as shown in FIGS. 7A-7F. With reference to FIGS. 7A-7B, the side tension media and side tensioners 85 and the side wall brackets 86 can be removed. FIG. 7C is a close-up view following removal of the middle support 87. FIG. 7D is a close-up view following removal of the front support 88. As shown in FIGS. 7E-7F, the rear mounting hardware 89 can be shifted 180 degrees (from what is shown in FIG. 7E to what is shown in FIG. 7F) so that welded nuts are in a top-facing orientation. After following these steps, 3D cassettes and/or flip-flow media can be mounted in position. These disclosed modifications can add flip flow media to a top deck of the deck screener, thereby providing additional liberation of carry-over fiber that is not removed from the first screening apparatus 70. Conventionally, such deck screeners can include flip-flow capabilities on lower decks, but flip-flow capability is not provided on the upper deck. When processing “full term” bales containing flower, seed, hurd and fiber, it is contemplated that the disclosed flip-flow media features within the upper deck of the deck screener can provide additional agitation that helps liberate more of the flower from the stems carried-over from the first screening apparatus 70.

In use, it is contemplated that a flip-flow screener can increase vertical motion of hemp material to improve agitation, thereby providing better separation.

Although described in one example as a flip-flow screener, it is contemplated that the second screening apparatus 80 can be provided in other configurations. In one additional non-limiting example, the second screening apparatus 80 can comprise a VERMEER model 6450 trommel.

Optionally, it is contemplated that the second screening apparatus 80 can comprise two sets of screens, with each set of screens having openings of different dimensions to separate the hemp material into three different size classifications. It is contemplated that the three different size classifications can correspond to the hurd, grain, and biomass components of the hemp material received from the first screening apparatus 80. For example, the two screens can create classifications from 4/32″ up to 1″ round, triangular, slots or holes to create separation of the hurd, grain, and biomass components.

In exemplary aspects, the system 10 can further comprise first, second, and third outfeed conveyors 87, 88, 89. In these aspects, the first outfeed conveyor 87 can be configured to receive hurd components from the second screening apparatus 80, the second outfeed conveyor 88 can be configured to receive grain components from the second screening apparatus, and the third outfeed conveyor 89 can be configured to receive biomass components from the second screening apparatus.

In exemplary aspects, the second screening apparatus 80 can be configured to operate at a power output ranging from about 25 horsepower to about 125 horsepower to provide a throughput capacity of at least 20 tons of material per hour.

In further aspects, the system 10 can further comprise tracks to which the second screening apparatus 80 is movably coupled. By mounting the second screening apparatus 80 on tracks, it is contemplated that the second screening apparatus can be positioned independently of transportation needs and can be considered self-contained. Optionally, the second screening apparatus 80 and the first, second, and third outfeed conveyors 87, 88, 89 can all be mounted to a common chassis.

### H. Micronizing and Collecting

Micronizing is a result of the impact pressure created by the mill at high speed. In exemplary aspects, the system can further comprise a first collection hood in communication with the barrel 58 of the first screening apparatus 50. In these aspects, it is contemplated that the fiber collection apparatus 70 can be in communication with the first collection hood. In further aspects, the system can further comprise a second collection hood in communication with an inlet region of the mill apparatus 20. In these aspects, it is contemplated that the fiber collection apparatus 70 can be in communication with the second collection hood. In exemplary aspects, the fiber collection apparatus 70 can comprise a surge bin.

In use, it is contemplated that collection of micronized material can be accomplished by a 25-50 horsepower axil fan fed from collection hoods and hoses located at the inlet of the mill apparatus 20 and/or barrel of the first screening apparatus 50. The material can be collected via the fiber collection apparatus 70 (e.g., a surge bin), which can optionally have a capacity of (2) tons per hour and a particle size of 50-200 microns.

In exemplary aspects, it is contemplated that the moisture content of the collected fiber material can be less than 3% by weight at an ambient humidity reading of less than 55% during processing.

It is further contemplated that the disclosed systems and methods can allow for collection of CBD “keif”' or dust suitable for cannabinoid extraction.

In further aspects, it is contemplated that the collection apparatuses disclosed herein can have on-board air compressors and/or generators that are large enough to be considered self-contained and to support the processing system.

### I. Packaging

Repackaging of the separated commodities can include compression of the respective commodities at a minimum of a 2-1 ratio and/or stabilization of the material such that the material can be considered inert or in silage, protected from the elements, ultra violet light and decomposition. Package sizing can meet standard shipping weights and dimensions common in the transportation and manufacturing industries as moved by machines in 4′ to 5′ round bales.

In exemplary aspects, the system 10 can comprise a fiber packaging apparatus 116 that receives fiber components from the fiber collection apparatus 70. In further aspects, the system 10 can comprise first, second, and third packaging apparatuses 110, 112, 114, wherein the first outfeed conveyor 87 is configured to deliver hurd components to the first packaging apparatus, the second outfeed conveyor 88 is configured to deliver grain components to the second packaging apparatus, and the third outfeed conveyor 89 is configured to deliver biomass components to the third packaging apparatus.

In further aspects, it is contemplated that each respective packaging apparatus can optionally comprise a respective baler, such as, for example and without limitation, an ORKEL round baler. In these aspects, the fiber packaging apparatus 116 can be configured to produce a bale of compressed fiber, the first packaging apparatus 110 can be configured to produce a bale of compressed hurd components, the second packaging apparatus 112 can be configured to produce a bale of compressed grain components, and the third packaging apparatus 114 can be configured to produce a bale of compressed biomass components.

In further exemplary aspects, the system 10 can further comprise at least one transport apparatus 120 that is configured to engage and transport one or more of the bale of compressed fiber components, the bale of compressed hurd components, the bale of compressed grain components, and/or the bale of compressed biomass components. Optionally, the transport apparatus 120 can be a skid steer loader, a telehandler, or a tractor having a compression fork (to avoid puncturing of wrapping). It is contemplated that bale wrap can be considered non-flammable and safe for storage or for transportion without additional protection.

### J. Description of Products

In exemplary aspects, the commodities produced by the disclosed systems and methods can be: bast fiber with less than 5% hurd by weight in lengths from ½″ to 12″, hurd with less than 12%, less than 10%, less than 9%, or less than 8% impurities in sizes from micronized to 4″ pieces, biomass free of mature seed, and seed with less than 12%, less than 10%, less than 9%, or less than 8% impurities by weight.

Examples of products derived from the commodities include, but are not limited to: animal products, such as animal bedding and cat litter, building materials, such as hempcrete (hurd, lime, binder, water) for panels and blocks and hemp fiber insulation, packaging/shipping materials such as mycelium cultivation substrate (bio-based Styrofoam replacement), paper, cardboard, and composite shipping pallets, and bioplastic/biopolymers such as bio-plastic for water bottles and straws, medical grade plastic, and composites. The qualities that make these commodities ideal materials for the aforementioned applications are detailed below.

### 1. Animal Products

Hemp hurd is an ideal material for animal products for numerous reasons.

The material is remarkably absorbent. Hemp hurd bedding rapidly absorbs urine to keep animals dry and comfortable. It also helps confine and reduce the reduce the size of wet spots that can then be more easily removed. It is further contemplated that the anti-microbial and anti-fungal properties of hemp hurd material can lead to a reduction or avoidance of pests.

Secondly, because hemp hurd is extremely absorbent, it is highly durable and long-lasting compared to conventional materials such as wood shavings or straw.

Hurd animal bedding is also clean and safe, as the material is not bleached and no chemicals are added at any stage of processing. For this reason, hemp hurd animal bedding is also ideal for animals with respiratory problems.

The loose, open structure and pores of the hemp hurd helps to ensure ventilation and effective odor and temperature control. The unique thermal structure of hemp hurd makers bedding warmer in the winter and cooler in the summer.

Hemp hurd animal products are completely biodegradable. For example, within 8 weeks, hemp hurd animal bedding will have completely bio-degraded and have turned into a highly fertile organic fertilizer ideal for garden compost. It also reduces the size of muck piles and the related disposal.

### 2. Building Materials

Hemp hurd and fiber are effective materials for building materials for various reasons.

For example, Hempcrete has an R-value of between 2.4 and 4.8 per inch, making it a good option for energy efficiency. By comparison, concrete has an R-value of 0.1 to 0.2 per inch.

Hempcrete is a low density material, and thus, very durable, leading to a reduction in structural load requirements.

Thirdly, Hempcrete is both fire-and mold-resistant, making it an excellent option for homes, outbuilding, or other structures.

The non-toxic nature of hempcrete makes it an ideal option for promoting healthy indoor air quality. Many hemp homeowners state that they have less problems with allergies compared to traditional homes.

Lastly, hempcrete has a low carbon footprint. Compared to a traditional brick building of the same size, hempcerete has up to a 40% lower carbon footprint.

### 3. Packaging/Shipping Materials

Retailers are banning wooden pallets due to their propensity to attract insects and contain mold and mildew. Hemp composite pallets are anti-microbial, anti-bacterial and don't attract pests. By varying the composite formulation including hemp hurd, the pallets can be made to last 100 years or become biodegradable over time.

Secondly, Hemp hurd is an excellent substrate or growing medium for mycelium, a bio-based Styrofoam replacement.

### 4. Bioplastic/Biopolymers

Hemp plastic and polymers are biodegradable and the best solution to replace petroleum based plastic products. Hemp hurd is the base raw material to produce biodegradable plastics and polymers.

Secondly, the cellulose fibers in hurd are strong, have excellent interfacial adhesion with elastomers, bio based polymers and petroleum based polymers (PP and PE). The potential for hurd cellulose fibers in plastic and coatings in industrial applications is impressive. Compared to petroleum-based plastics, hemp plastic is 3.5 times stronger and 5 times stiffer.

Lastly, hemp plastic is non-toxic, biodegradable, durable and versatile. Food and pharmaceutical-grade hemp plastics and cellophane will be in high demand. When made with biodegradable polymers, hemp plastic is completely biodegradable, unlike regular plastics

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system comprising:
a mill apparatus configured to receive hemp material;
a first screening apparatus configured to receive milled hemp material from the mill apparatus, wherein the first screening apparatus is configured to separate fiber components of the milled hemp material from hurd, grain, and biomass components of the milled hemp material; and
a fiber collection apparatus configured to receive, from the first screening apparatus, the fiber components of the milled hemp material.

Aspect 2: The system of aspect 1, further comprising:
a second screening apparatus configured to receive, from the first screening apparatus, the hurd, grain, and biomass components of the milled hemp material, wherein the second screening apparatus is configured to separate the hurd, grain, and biomass components.

Aspect 3: The system of aspect 2, further comprising:
a hurd collection apparatus configured to receive, from the second screening apparatus, the hurd components of the milled hemp material;
a grain collection apparatus configured to receive, from the second screening apparatus, the grain components of the milled hemp material; and
a biomass collection apparatus configured to receive, from the second screening apparatus, the biomass components of the milled hemp material.

Aspect 4: The system of any one of the preceding aspects, further comprising a loading apparatus configured to deliver hemp material to the mill apparatus.

Aspect 5: The system of aspect 4, wherein the loading apparatus comprises a skid steer loader.

Aspect 6: The system of aspect 4, wherein the loading apparatus comprises a telehandler.

Aspect 7: The system of aspect 4, wherein the loading apparatus comprises a tractor.

Aspect 8: The system of aspect 7, wherein the tractor comprises a knife that is configured to cut a bale of the hemp material.

Aspect 9: The system of any one of the preceding aspects, wherein the mill apparatus comprises a horizontal block mill or grinder.

Aspect 10: The system of aspect 9, wherein the mill apparatus comprises wear blocks.

Aspect 11: The system of aspect 10, wherein at least a portion of the wear blocks have respective slots that define a cross pattern.

Aspect 12: The system of any one of aspects 9-11, wherein the mill apparatus comprises a plurality of hammers, wherein at least one hammer of the plurality of hammers has a hammer tip structure having a raised pattern with angled surfaces.

Aspect 13: The system of aspect 12, wherein the hammer tip structure comprises a plurality of triangular plates.

Aspect 14: The system of aspect 13, wherein at least a portion of the plurality of triangular plates are welded together to increase a number of impact angles.

Aspect 15: The system of aspect 13 or aspect 14, wherein the raised pattern comprises respective pairs of triangular plates that cooperate to form diamond-shaped sections of the raised pattern.

Aspect 16: The system of any one of aspects 12-15, wherein the raised pattern comprises welds that are impregnated with hard or wear-resistant material.

Aspect 17: The system of any one of the preceding aspects, wherein the mill apparatus comprises an in-feed conveyor configured to receive the hemp material from a loading apparatus.

Aspect 18: The system of any one of the preceding aspects, wherein the mill apparatus comprises an outfeed conveyor in communication with the first screening apparatus, wherein the outfeed conveyor is configured to deliver milled hemp material to the first screening apparatus.

Aspect 19: The system of any one of the preceding aspects, wherein the mill apparatus comprises a screen through which hemp material passes.

Aspect 20: The system of any one of the preceding aspects, further comprising tracks to which the mill apparatus is movably coupled.

Aspect 21: The system of any one of the preceding aspects, wherein the first screening apparatus comprises a rotary screen that is configured to receive milled hemp material from the mill apparatus.

Aspect 22: The system of any one of the preceding aspects, wherein the first screening apparatus is a trommel having a screen retainer.

Aspect 23: The system of aspect 21 or aspect 22, wherein the first screening apparatus comprises an inlet hopper in communication with the mill apparatus.

Aspect 24: The system of any one of aspects 21-23, wherein the first screening apparatus comprises a barrel having a length of at least 30 feet and a diameter of at least 5 feet.

Aspect 25: The system of aspect 24, further comprising a center shaft about which the rotary screen rotates.

Aspect 26: The system of aspect 25, further comprising at least one paddle assembly coupled to the center shaft, each paddle assembly of the at least one paddle assembly comprising a plurality of paddles that project radially away from the center shaft, wherein the plurality of paddles of each paddle assembly are configured to effect rotation of the paddle assembly in response to impact between hemp material and at least one paddle of the plurality of paddles.

Aspect 27: The system of any one of aspects 21-26, wherein the rotary screen has openings with dimensions ranging from ⅛ inch to 1 inch.

Aspect 28: The system of any one of aspects 21-27, wherein the rotary screen has a free or open area of at least 50%.

Aspect 29: The system of any one of aspects 24-28, wherein the barrel is angularly oriented relative to horizontal.

Aspect 30: The system of aspect 29, wherein the barrel is angled at 4 to 6 degrees relative to horizontal

Aspect 31: The system of any one of aspects 21-30, further comprising an outfeed conveyor configured to receive hemp material passing through the rotary screen.

Aspect 32: The system of any one of aspects 2-31, wherein the second screening apparatus has an inlet hopper in communication with the first screening apparatus.

Aspect 33: The system of any one of aspects 2-32, wherein the second screening apparatus comprises a deck screener configured to move in at least two axis.

Aspect 34: The system of aspect 33, wherein the deck screener has dimensions of at least five feet by at least 15 feet.

Aspect 35: The system of any one of aspects 2-34, wherein the second screening apparatus comprises two sets of screens, each set of screens having openings of different dimensions to separate the hemp material into three different size classifications.

Aspect 36: The system of any one of aspects 32-35, further comprising tracks to which the second screening apparatus is movably coupled.

Aspect 37: The system of any one of aspects 2-36, further comprising first, second, and third outfeed conveyors, wherein the first outfeed conveyor is configured to receive hurd components from the second screening apparatus, wherein the second outfeed conveyor is configured to receive grain components from the second screening apparatus, and wherein the third outfeed conveyor is configured to receive biomass components from the second screening apparatus.

Aspect 38: The system of any one of aspects 24-37, further comprising a first collection hood in communication with the barrel of the first screening apparatus.

Aspect 39: The system of aspect 38, wherein the fiber collection apparatus is in communication with the first collection hood.

Aspect 40: The system of aspect 39, further comprising a second collection hood in communication with an inlet region of the mill apparatus.

Aspect 41: The system of aspect 40, wherein the fiber collection apparatus is in communication with the second collection hood.

Aspect 42: The system of any one of aspects 39-41, wherein the fiber collection apparatus is a surge bin.

Aspect 43: The system of aspect 42, wherein the surge bin has a capacity of at least 2 tons per hour and a particle size range of 50-200 microns.

Aspect 44: The system of any one of aspects 37-43, further comprising first, second, and third packaging apparatuses, wherein the first outfeed conveyor is configured to deliver hurd components to the first packaging apparatus, wherein the second outfeed conveyor is configured to deliver grain components to the second packaging apparatus, and wherein the third outfeed conveyor is configured to deliver biomass components to the third packaging apparatus.

Aspect 45: The system of aspect 44, wherein the first, second, and third packaging apparatuses each comprise a respective baler, wherein the first packaging apparatus is configured to produce a bale of compressed hurd components, wherein the second packaging apparatus is configured to produce a bale of compressed grain components, and wherein the third packaging apparatus is configured to produce a bale of compressed biomass components.

Aspect 46: The system of aspect 44 or aspect 45, further comprising at least one transport apparatus that is configured to engage and transport the bale of compressed hurd components, the bale of compressed grain components, and/or the bale of compressed biomass components.

Aspect 47: The system of aspect 46, wherein the transport apparatus is a skid steer loader, a telehandler, or a tractor having a compression fork.

Aspect 48: The system of any one of the preceding aspects, wherein the mill apparatus and the first screening apparatus are provided on a common chassis.

Aspect 49: The system of aspect 48, wherein the common chassis comprises a trailer.

Aspect 50: A method of using the system of any one of the preceding aspects, comprising:
milling, by the mill apparatus, hemp material;
separating, by the first screening apparatus, fiber components of the milled hemp material from hurd, grain, and biomass components of the milled hemp material; and
collecting, by the fiber collection apparatus, the fiber components of the milled hemp material.

Aspect 51: The method of aspect 50, further comprising:
separating, by a second screening apparatus, the hurd, grain, and biomass components of the milled hemp material;
collecting, by a hurd collection apparatus, the hurd components of the milled hemp material;
collecting, by a grain collection apparatus, the grain components of the milled hemp material; and
collecting, by a biomass collection apparatus, the biomass components of the milled hemp material.

Aspect 52: The method of aspect 50 or aspect 51, further comprising packaging the collected fiber components of the milled hemp material.

Aspect 53: The method of aspect 51 or aspect 52, further comprising:
packaging the hurd components of the milled hemp material;
packaging the grain components of the milled hemp material; and
packaging the biomass components of the milled hemp material.

Aspect 54: The method of any one of aspects 50-53, wherein the method is performed onsite at a farm.

Aspect 55: The method of any one of aspects 50-54, wherein the hemp material is provided to the mill apparatus as a bale or half bale.

Aspect 56: The method of aspect 55, wherein the hemp material is provided to the mill apparatus with wrapping.

Aspect 57: The method of aspect 56, further comprising cutting the bale of hemp material prior to providing the hemp material to the mill apparatus.

Aspect 58: The method of any one of aspects 55-57, wherein the bale or half bale of hemp material has a moisture content ranging from 8-25%.

Aspect 59: The method of any one of aspects 50-58, wherein the mill apparatus and the first screening apparatus process at least 30 tons of hemp material per hour.

Aspect 60: The method of any one of aspects 51-59, wherein the second screening apparatus processes at least 20 tons of milled hemp material per hour.

Aspect 61: The method of any one of aspects 50-54 or 59-60, wherein the hemp material comprises hemp stalks.

Aspect 62: The method of any one of aspects 50-61, wherein the collected fiber components of the hemp material have a moisture content that is less than 3% by weight at an ambient humidity reading of less than 55%.

Aspect 63: The method of any one of aspects 50-62, wherein the collected fiber components have less than 5% hurd by weight and are provided in lengths ranging from ½ inch to 12 inches.

Aspect 64: The method of any one of aspects 51-63, wherein the collected hurd components have less than 10% impurities by weight and are provided in sizes of four inches or less.

Aspect 65: The method of any one of aspects 51-64, wherein the collected biomass components are free of mature seed.

Aspect 66: The method of any one of aspects 51-65, wherein the collected grain components have less than 10% impurities by weight.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A system comprising:
a mill apparatus configured to receive hemp material;
a first screening apparatus configured to receive milled hemp material from the mill apparatus, wherein the first screening apparatus is configured to separate fiber components of the milled hemp material from hurd, grain, and biomass components of the milled hemp material; and
a fiber collection apparatus configured to receive, from the first screening apparatus, the fiber components of the milled hemp material.

2. The system of claim 1, further comprising:
a second screening apparatus configured to receive, from the first screening apparatus, the hurd, grain, and biomass components of the milled hemp material, wherein the second screening apparatus is configured to separate the hurd, grain, and biomass components.

3. The system of claim 2, further comprising:
a hurd collection apparatus configured to receive, from the second screening apparatus, the hurd components of the milled hemp material;
a grain collection apparatus configured to receive, from the second screening apparatus, the grain components of the milled hemp material; and
a biomass collection apparatus configured to receive, from the second screening apparatus, the biomass components of the milled hemp material.

4. The system of claim 1, further comprising a loading apparatus configured to deliver hemp material to the mill apparatus.

5. The system of claim 4, wherein the loading apparatus comprises a skid steer loader, a telehandler, or a tractor.

6. (canceled)

7. (canceled)

8. (canceled)

9. The system of claim 1, wherein the mill apparatus comprises a horizontal block mill or grinder.

10. (canceled)

11. (canceled)

12. (canceled)

13. (canceled)

14. (canceled)

15. (canceled)

16. (canceled)

17. The system of claim 1, wherein the mill apparatus comprises an in-feed conveyor configured to receive the hemp material from a loading apparatus.

18. The system of claim 1, wherein the mill apparatus comprises an outfeed conveyor in communication with the first screening apparatus, wherein the outfeed conveyor is configured to deliver milled hemp material to the first screening apparatus.

19. The system of claim 1, wherein the mill apparatus comprises a screen through which hemp material passes.

20. (canceled)

21. The system of claim 1, wherein the first screening apparatus comprises a rotary screen that is configured to receive milled hemp material from the mill apparatus.

22. The system of claim 1, wherein the first screening apparatus is a trommel having a screen retainer.

23. The system of claim 1, wherein the first screening apparatus comprises an inlet hopper in communication with the mill apparatus.

24. The system of claim 1, wherein the first screening apparatus comprises a barrel having a length of at least 30 feet and a diameter of at least 5 feet.

25. The system of claim 21, further comprising a center shaft about which the rotary screen rotates.

26. (canceled)

27. (canceled)

28. (canceled)

29. The system of claim 24, wherein the barrel is angularly oriented relative to horizontal.

30. (canceled)

31. The system of claim 21, further comprising an outfeed conveyor configured to receive hemp material passing through the rotary screen.

32. (canceled)

33. The system of claim 2, wherein the second screening apparatus comprises a deck screener configured to move in at least two axis.

34. (canceled)

35. (canceled)

36. (canceled)

37. The system of claim 2, further comprising first, second, and third outfeed conveyors, wherein the first outfeed conveyor is configured to receive hurd components from the second screening apparatus, wherein the second outfeed conveyor is configured to receive grain components from the second screening apparatus, and wherein the third outfeed conveyor is configured to receive biomass components from the second screening apparatus.

38. (canceled)

39. (canceled)

40. (canceled)

41. (canceled)

42. (canceled)

43. (canceled)

44. The system of claim 37, further comprising first, second, and third packaging apparatuses, wherein the first outfeed conveyor is configured to deliver hurd components to the first packaging apparatus, wherein the second outfeed conveyor is configured to deliver grain components to the second packaging apparatus, and wherein the third outfeed conveyor is configured to deliver biomass components to the third packaging apparatus.

45. (canceled)

46. (canceled)

47. (canceled)

48. The system of claim 1, wherein the mill apparatus and the first screening apparatus are provided on a common chassis.

49. (canceled)

50. A method of using the system of claim 1, comprising:
milling, by the mill apparatus, hemp material;
separating, by the first screening apparatus, fiber components of the milled hemp material from hurd, grain, and biomass components of the milled hemp material; and
collecting, by the fiber collection apparatus, the fiber components of the milled hemp material.

51. The method of claim 50, further comprising:
separating, by a second screening apparatus, the hurd, grain, and biomass components of the milled hemp material;
collecting, by a hurd collection apparatus, the hurd components of the milled hemp material;
collecting, by a grain collection apparatus, the grain components of the milled hemp material; and
collecting, by a biomass collection apparatus, the biomass components of the milled hemp material.

52. (canceled)

53. (canceled)

54. The method of claim 50, wherein the method is performed onsite at a farm.

55. (canceled)

56. (canceled)

57. (canceled)

58. (canceled)

59. (canceled)

60. The method of claim 51, wherein the second screening apparatus processes at least 20 tons of milled hemp material per hour.

61. (canceled)

62. (canceled)

63. (canceled)

64. (canceled)

65. (canceled)

66. (canceled)
